(19) United States
(12) Patent Application Publication
(10) Pub. No.: US 2004/0135991 A1
(43) Pub. Date: Jul. 15, 2004

(54) Portable laser distance measuring device

(76) Inventors: Torsten Gogolla, Schaan (LI); Andreas Winter, Feldkirch (AT); Dietmar Fritz Karl Kuhlmann, Au/SG (CH)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/696,306

(22) Filed: Oct. 27, 2003

(30) Foreign Application Priority Data
Nov. 13, 2002 (DE) 102 52 743.1

(51) Int. Cl. G01C 3/08

(52) U.S. Cl. 356/4.01

(57) ABSTRACT

A portable laser distance measuring device (1) with an optoelectronic transmitter (2a) and receiver (2b) and an input (4) such as mode selection switches and an output (5) such as a liquid crystal display arranged on a convenient housing (3), which are arranged at least in part on a cover plate (6). At least one additional input (7) such as a push-button triggering the measuring operation is arranged on a side panel (8) adjacent to the cover plate (6).

### BACKGROUND OF THE INVENTION

The invention relates to a portable laser distance measuring instrument, in particular a distance measuring instrument for use on construction sites.

Conventionally, portable laser distance measuring instruments have an optoelectronic transmitter and receiver, input means such as switches and buttons and output means such as liquid displays, arranged on a convenient housing.

According to DE 1 005 510, a portable laser distance measuring instrument has the input means and output means exclusively on the top panel of an essentially parallel piped housing. One-handed handling and operation of the measurement key triggering the measurement operation is hardly possible in specific measurement situations such as overhead measurements that occur frequently in measurements on walls near the ceiling because the ergonomic lateral clamp grip of the housing between the thumb and the other fingers does not allow simultaneous operation of the measurement key.

Additionally, DE 4 121 625 discloses a portable gas measurement device having a measurement key near the lateral edge arranged in a finger depression, whereby in addition to frontal operation the device can be actuated with one finger even when holding the housing with the back, in the palm of the hand. This handling is unsuitable for overhead measurements.

### SUMMARY OF THE INVENTION

The object of the invention is to provide a portable laser distance measuring instrument for ergonomic overhead measuring operations.

This object is achieved essentially by a portable laser distance measuring device having an optoelectronic transmitter and receiver and input and output. means arranged on a convenient housing, which are in part arranged on a cover plate, whereby at lease one additional input means triggering the measuring operation is arranged on one of the side panels adjacent to the cover plate.

At least one of the additional input means on one of the side panels adjacent to the cover plate triggering the measuring operation can be actuated by virtue of this layout, in overhead measuring operations, with one finger and with the ergonomic holding of the housing in the lateral clamp grip.

Advantageously, the additional input means is a push-button, wherein it is actuated along the ergonomic finger movement.

Advantageously, the additional input means is logically OR connected with the associated input means triggering the measuring operation, whereby an alternative actuation is possible.

Advantageously, the position of the additional input means is identified using a further advantageously illuminated marking on the cover plate, whereby a searching sensor is supported.

### BRIEF DESCRIPTION OF THE INVENTION

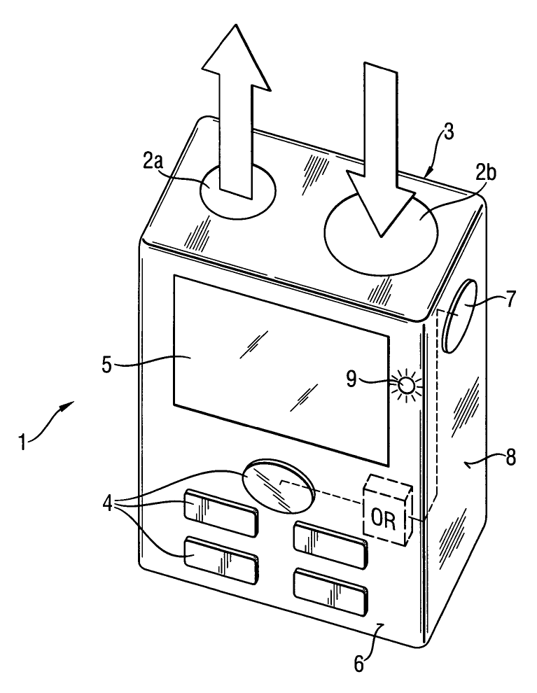

The exemplary embodiment of the invention will be more completely explained with reference to the drawings, wherein FIG. 1 shows a portable laser distance measuring device according to the invention.

### DETAILED DESCRIPTION OF THE INVENTION

According to the representation, a portable laser distance measuring device 1 has an optoelectronic transmitter 2a and receiver 2b for a visible laser beam and input means 4, in the form of mode selection switches and the main measurement key, and output means 5, in the form of a liquid crystal display, arranged on a convenient, parallel piped housing, said means being at least partially arranged on a cover plate 6, wherein at least one additional input means 7 triggering the measuring operation is arranged on a side panel 8 adjacent to the cover plate 6. The additional input means 7 is a push-button, which is connected logically OR with the main key associated with the input means 4. The position of the additional input means 7 is visibly identified using a fluorescing marking 9 on the cover plate 6.

What is claimed is:

1. A portable laser distance measuring device with an optoelectronic transmitter and receiver (2) and input means (4) and output means (5) arranged on a convenient housing (3), wherein the input means (4) and the output means (5) are arranged at least in part on a cover plate (6), and wherein at least one additional input means (7) triggering the measuring operation is arranged on a side panel (8) adjacent to the cover plate (6).

2. The laser distance measuring device of claim 1, wherein the additional input means (7) is a push-button.

3. The laser distance measuring device of claim 1, wherein the additional input means (7) is logically OR connected with the associated input means (4) triggering the measuring operation.

4. The laser distance measuring device of claim 3, wherein the position of the additional input means (7) is visibly identified using an optionally illuminated marking (9) on the cover plate (6).
